(19) United States
(12) Patent Application Publication
(10) Pub. No.: US 2016/0171258 A1
(43) Pub. Date: Jun. 16, 2016

(54) SYSTEM AND METHOD FOR DETECTING AND PROCESSING CODES

(71) Applicant: AGFA HEALTHCARE, Bonn (DE)

(72) Inventor: Martin REITSTAETTER, Mortsel (BE)

(21) Appl. No.: 14/909,482

(22) PCT Filed: Aug. 26, 2014
(86) PCT No.: PCT/EP2014/068025

§ 371 Date: Feb. 2, 2016

(30) Foreign Application Priority Data
Aug. 28, 2013 (EP) 13182006.0

(51) Int. Cl. G06K 7/10; G06K 19/06

(52) U.S. Cl. CPC G06K 7/10158; G06K 19/06028

(57) ABSTRACT

A system and corresponding method for detecting and processing codes, in particular barcodes, and in particular in a healthcare environment. The system includes at least one peripheral module and a central module. The at least one peripheral module includes a code reader adapted for reading codes, a transmitter adapted for transmitting code data corresponding to the codes read by the code reader, a receiver adapted for receiving information data, and an output device adapted for outputting messages corresponding to the information data received by the receiver. The central module includes a receiver adapted for receiving the code data transmitted from the transmitter of the at least one peripheral module, a processor adapted for processing the code data received by the receiver and generating the information data to be received by the receiver of the at least one peripheral module depending on the processed code data, and a transmitter adapted for transmitting the information data generated by the processor. Thus, it is possible to detect codes and to transmit them to a central module for further processing in easy and flexible manner.

### CROSS-REFERENCE TO RELATED APPLICATIONS

This application is a 371 National Stage Application of PCT/EP2014/068025, filed Aug. 26, 2014. This application claims the benefit of European Application No. 13182006.0, filed Aug. 28, 2013, which is incorporated by reference herein in its entirety.

### BACKGROUND OF THE INVENTION

1. Field of the Invention

The invention relates to a system and a method for detecting and processing codes, in particular barcodes.

2. Description of the Related Art

In prior art systems, barcode scanners or RFID readers, which can read barcodes or RFID codes, respectively, provided on goods or items, like drugs or medical equipment, are connected to a central module or terminal by a USB or serial interface. Due to the cable link, however, such code readers are somewhat inconvenient to use. In case of serial interfaces problems regarding availability of functioning drivers often arise.

In some application fields, for example in healthcare services, the desired information is not always encoded in a single code but rather spread over several codes. For example, the serial number, the lot number, the expiration date etc. of a certain item may be provided in different codes which may be located at different positions or sites. As a result, it is often necessary to carry out a few scanning processes to get all information needed. In prior art systems, those procedures are somewhat inconvenient for the user and/or require peripheral modules having complex configurations.

### SUMMARY OF THE INVENTION

Preferred embodiments of the invention provide an improved system and method for detecting and processing codes, in particular in a healthcare environment, which allow for detecting codes and transmitting them to a central module for further processing in easy and flexible manner and, preferably, with a simple construction of the peripheral code scanning module.

The system for detecting and processing codes according to a preferred embodiment of the invention comprises a central module and at least one peripheral module. The at least one peripheral module comprises a code reader being adapted for reading codes, a transmitter being adapted for transmitting code data corresponding to the codes read by the code reader, a receiver being adapted for receiving information data, and an output device being adapted for outputting messages corresponding to the information data received by the receiver. The central module comprises a receiver being adapted for receiving the code data transmitted from the transmitter of the at least one peripheral module, a processor being adapted for processing the code data received by the receiver and generating the information data to be received by the receiver of the at least one peripheral module depending on the processed code data, and a transmitter being adapted for transmitting the information data generated by the processor.

In a method for detecting and processing codes according to a preferred embodiment of the invention a code is detected by a peripheral module, code data corresponding to the code detected by the peripheral module are transmitted to a central module, the code data are processed by the central module, information data are generated by the central module depending on the processed code data, the information data are transmitted from the central module to the peripheral module, and a message corresponding to the information data is outputted by the peripheral module.

Preferred embodiments of the invention are based on the approach to provide a peripheral module including a relatively simple software application but nevertheless allowing to detect codes, like barcodes, and to transmit corresponding code data to a central module for further processing. In general, there may be a number of peripheral modules. The central module, which is required only once, may be configured more complex and is adapted to process the code data received from the peripheral module and to generate and transmit information data, which depend on the result of the processing of the code data, to the peripheral module, where the received information data or corresponding messages are outputted, in particular displayed, to the user who currently uses the peripheral module. The outputted information data or messages preferably contain information or instructions to the user as to possible further steps to be carried out, e.g., a request to read one or more further codes by the code reader or a confirmation that all necessary information has been read and/or that the reading of further codes can be stopped.

It is, therefore, a particularly advantageous aspect of the invention that information data, to which messages outputted by the output device of the at least one peripheral module correspond, are generated by the processor of the central module. As a result, only the central module has to be provided with a more complex software application which is, i.a., configured to determine or generate information data based on the code data received from the at least one peripheral module, whereas the software application implemented in the at least one peripheral module can be less complex and, in particular, does not require a particular driver software. In particular, the software application of the peripheral module is configured to supervise the code reader of the peripheral module and, when the code reader has scanned a barcode, to transmit the corresponding code data to the central module. Upon receipt of a response, i.e. information data, from the central module, the response is displayed on the display of the peripheral module. As the software application of the peripheral module is as simple as possible it can be quickly transferred to different operating systems of the peripheral modules without the need of an installation of particular diver software for each of the different operating systems of the peripheral modules.

According to another particularly advantageous aspect of the invention, the processor of the central module is configured to process the code data received from the peripheral module. Preferably, a database contains information data assigned to code data that may be received from the peripheral module, wherein the information data contain information as to, i.a., the kind of code received from the peripheral module and/or whether one or more further codes have to be read by the peripheral module and, in the affirmative, which kind of code or codes have to be read by the peripheral module. Accordingly, when processing the received code data, the processor determines and/or generates information data by retrieving the information data (e.g., kind of code and/or possible further codes to be read) assigned to the received code data from the database. For example, based on the information data stored in the database the kind of the received code data is recognized to represent an item number. Moreover, due to further information data assigned with this kind of received code data and/or item it is recognized that this kind of received code or item, respectively, requires another kind of code data, e.g. a lot number and/or an expiration date encoded in another barcode provided on the item, to be scanned by the peripheral module. The obtained information data are transmitted to the peripheral module and outputted at the output device of the peripheral module, for example, by displaying “Scanned item requires a lot number. Please also scan the lot number . . . ” Preferably, the central module is configured to enable an input, e.g. a user input, of information data, to assign the inputted information data to code data and to store both the inputted information data and the respective code data in the database. In this way, any desired kind of information data (e.g., kinds of codes, codes to be read, respective instructions to a user) can be defined and/or configured by a user and/or by a system administrator rendering the system and method particularly flexible in view of different applications, e.g. in a hospital environment, in which any relevant information contained in different kinds of codes provided on different goods and/or services can be reliably captured.

In summary, the system and method according to preferred embodiments of the invention allow for a detection of codes and transmission of respective code data to a central module for further processing in easy and flexible manner, in particular with a simple construction of the peripheral module.

The system and method can preferably be used in a healthcare environment, like a hospital information system (HIS), especially for documentation and administration tasks.

The codes to be read by the code reader of the at least one peripheral module are preferably machine readable codes, including one and two dimensional optically readable codes such as barcodes, and radio frequency identification (RFID) tags. Accordingly, the code reader of the at least one peripheral module is preferably configured as an optical code scanner or an RFID reader. In case the system comprises at least two peripheral modules, one of them may comprise an optical code scanner and another of them may comprise an RFID reader.

The output device of the at least one peripheral module is preferably configured to output messages in an optical and/or acoustic manner. Accordingly, the output device comprises a display and/or a speaker.

According to a preferred embodiment of the invention, the transmitter and/or the receiver of the at least one peripheral module are adapted for transmitting code data or receiving information data, respectively, in a wireless manner, and the receiver and/or the transmitter of the central module are adapted for receiving code data or transmitting information data, respectively, in a wireless manner. As a result, the central module and the at least one peripheral module can communicate with each other in a wireless manner. Preferably, the central module and the at least one peripheral module are adapted for communicating with each other via a wireless Local Area Network (WLAN). Preferably, that WLAN conforms to the Transmission Control Protocol/Internet Protocol (TCP/IP) industry standard.

The information data generated by the processor of the central module and the corresponding messages outputted by the output device of the at least one peripheral module may include any information being useful for the user of the system, preferably regarding the code detecting and processing procedure of the system.

According to a preferred embodiment of the invention, the information data include confirmation data as to whether the code data have been received by the receiver and processed by the processor of the central module successfully or not. With this configuration, the user can obtain information as to whether the code has been read, transmitted and processed by the peripheral module and the central module successfully or not. As a result, the user can obtain information as to whether it is necessary to read the respective code again or not in easy and reliable manner.

According to another preferred embodiment of the invention, the processor of the central module is connected to a database including data referring to the codes to be detected. That database may be positioned within the central module or the central module may be connected to that database being a component separate from the central module. In this configuration of the system, the information data can preferably include instruction data as to which further codes have to be detected and/or which further actions have to be carried out, the instruction data being generated by the processor of the central module depending on the data of the database referring to the code data received by the receiver of the central module. With this configuration, the user can obtain information as to whether further codes have to be read, transmitted and processed by the peripheral module and the central module or not and/or which further actions have to be carried out by the user, if any, depending on the code last read by the peripheral module and/or the documentation process, for example.

According to another preferred embodiment of the invention, the at least one peripheral module comprises a processor being adapted for processing the codes read by the code reader and generating the code data to be transmitted to the central module. Preferably, the processor of the at least one peripheral module is configured to just carry out a simple pre-processing of the codes read by the code reader.

It is preferred, that this processor of the at least one peripheral module is also adapted to determine whether the codes read by the code reader are codes to be transmitted to the central module or not.

According to a preferred embodiment of the invention, the at least one peripheral module is configured as a mobile and/or handheld device. For example, the peripheral module may be configured as a smartphone or tablet computer. With this configuration of the system, the codes can be detected in flexible manner and without disturbing other persons or devices by cable links.

The above is further achieved by a peripheral module comprising a code reader for reading codes, in particular barcodes, and being configured to be used in a system as described above.

Furthermore, the above is also achieved by a central module comprising a processor for processing code data and being configured to be used in a system as described above.

Further advantages, features and examples of the present invention will be apparent from the following description with reference to the accompanying drawings. In the drawings:

### BRIEF DESCRIPTION OF THE DRAWINGS

FIG. 1 shows a block diagram of an exemplary preferred embodiment of a system for detecting and processing codes of a preferred embodiment of the invention; and

FIG. 2 shows a diagrammatic chart of an exemplary preferred embodiment of a method for detecting and processing codes which can be carried out for example by the system shown in FIG. 1.

### DETAILED DESCRIPTION OF THE PREFERRED EMBODIMENTS

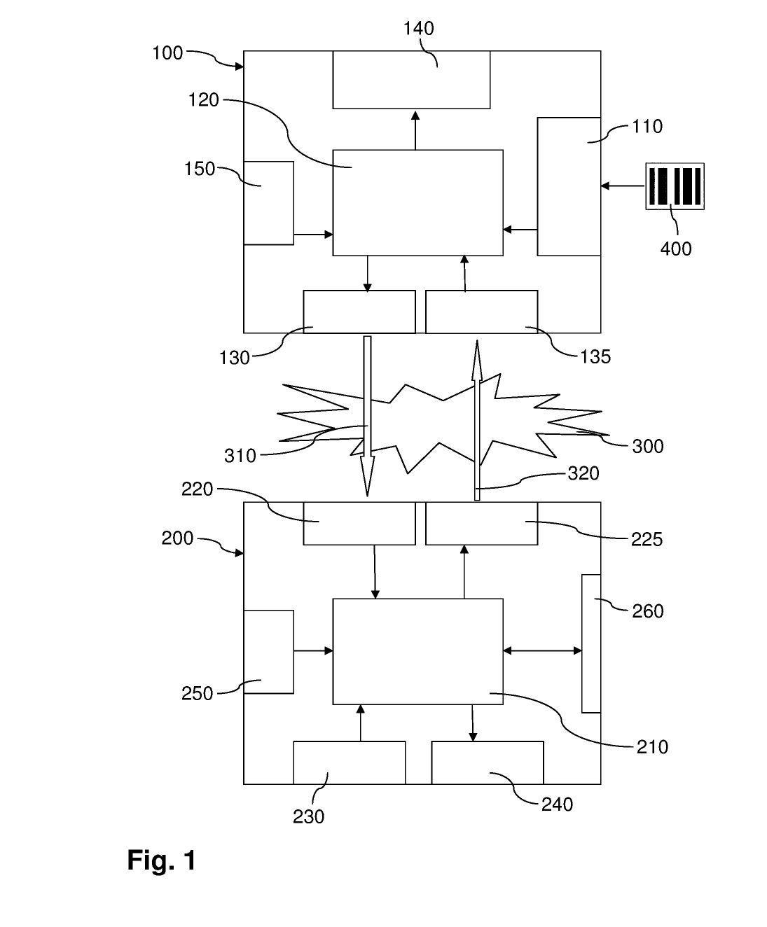

FIG. 1 shows an example of a system for detecting and processing codes according to a preferred embodiment of the invention. The system comprises at least one peripheral module 100 (only one is shown exemplarily in FIG. 1), preferably being configured as a handheld or mobile device, and a central module 200, preferably being configured as a computer or workstation. This system preferably may be used in healthcare environments, like a HIS, for administration and documentation tasks.

The peripheral module 100 comprises a code reader 110. Depending on the kind of codes 400 to be detected, this code reader may be configured as an optical code scanner for reading one or two dimensional optically readable barcodes or as an RFID reader for reading RFID tags, for example. The codes 400 may include, for example, serial numbers, item identifications, lot numbers, expiration dates, patient identifications and the like.

The code reader 110 is connected to a processor 120 comprising a microprocessor, for example. The processor 120 is adapted for pre-processing the codes read by the code reader, determining whether the codes read by the code reader have to be transmitted to the central module 200 or not, and generating code data 310 corresponding to the codes read by the code reader. Also, the processor 120 can judge whether the codes 400 have been detected correctly or not.

The processor 120 is connected to a transmitter 130 and a receiver 135. The transmitter 130 is adapted to transmit the code data 310 generated by the processor 120 in a wireless manner, and the receiver 135 is adapted to receive information data 320 from the central module 200 in a wireless manner. Especially, the transmitter 130 and the receiver 135 are adapted to communicate via a wireless Local Area Network (WLAN) 300 being in conformity with the Transmission Control Protocol/Internet Protocol (TCP/IP) industry standard.

Further, the processor 120 of the peripheral module 100 is connected to an output device 140, preferably in the form of a display. In addition or alternatively, the output device 140 may comprise a speaker for outputting messages in an acoustic manner. Especially, the output device 140 may output messages corresponding to the information data 320 received by the receiver 135 from the central module 200. These information data 320 may include confirmation data as to whether the code data 310 have been received and processed by the central module 200 successfully or not, and/or instruction data as to which further codes have to be detected and/or which further actions have to be carried out by the user (e.g. additional checkups carried out by a nurse or a doctor), these instruction data being dependent on the last code data 310. Also, the output device 140 may output messages as to whether the code 400 has been read by the code reader 110 successfully or not.

Furthermore, the processor 120 of the peripheral module 100 is connected to an input device 150. This input device 150 may comprise a scanner button for initiating a scanning process of the code reader 110, a first confirmation button for confirming that the message outputted by the output device 140 has been read, a second confirmation button for confirming that an action has been carried out which action has been demanded by the central module via the information data 320, and the like. The input device 150 may also be integrated with the output device 140, for example it may be configured as a touchscreen.

The central module 200 comprises also a processor 210 comprising a microprocessor, for example. The processor 120 is adapted for processing the code data 310 transmitted from the peripheral module 200 and generating the information data 320 to be transmitted to the peripheral module 100.

The processor 210 is connected to a receiver 220 and a transmitter 225. The receiver 220 is adapted to receive the code data 310 transmitted from the peripheral module 100 in a wireless manner, and the transmitter 225 is adapted to transmit the information data 320 generated by the processor 210 to the peripheral module 100 in a wireless manner. Similar to the transmitter 130 and the receiver 135 of the peripheral module 100, the receiver 220 and the transmitter 225 of the central module 200 are preferably adapted to communicate via a wireless Local Area Network (WLAN) 300 being in conformity with the Transmission Control Protocol/Internet Protocol (TCP/IP) industry standard.

As shown in FIG. 1, the processor 210 of the central module 200 is further connected to a database 230. This database 230 may be stored in an internal memory of the central module 200 or an external memory separate from the central module 200. The database 230 contains data referring to the codes 400 which may be read by the code reader 110 of the peripheral module 100. Especially, the database 230 may contain further information as to the kind of code, whether further codes 400 have to be read or not, whether further actions have to be carried out or not, associated with the respective codes contained in the database 230.

The information data 320 generated by the processor 210 of the central module 200 may be based on those data contained in the database 230. Further, the processor 210 may generate information data 320 as to whether the last code data 310 have been received and processed successfully or not. The processor 120 of the peripheral module 100 controls the output device 140 to output messages corresponding to these information data 320.

Similar to conventional computers and workstations, the processor 210 of the central module 200 is connected to an output device 240 (display, speaker, etc.), an input device 250 (keyboard, mouse, touchscreen, etc.) and further ports 260 to be connected to further devices (another computer, printer, internet, intranet, etc.). Especially, messages corresponding to the information data 320 generated by the processor 210 of the central module 200 can also be displayed on a display 240 of the central module 200.

The operation of the embodiment of the system shown in FIG. 1 will be illustrated exemplarily in the following.

At a checkstand of a supermarket, for example, only an item number is scanned to identify the corresponding item and to charge it. In medical documentation, however, more information may be provided in the form of barcodes: lot number, serial number, expiration date, etc. As this information is often spread over multiple barcodes it is necessary to carry out multiple scanning processes. The system achieves to make this as easy as possible for the user by analyzing the scanned codes 400 by the central module 200 and communicating to the user whether and which further barcodes 400 have to be scanned by the peripheral module 100.

For data and code communication, the system preferably uses the well-known standards GS1, HIBC, ISBT128, etc. The interpretation of the codes and the presentation of the feedback are carried out at the central module 200. Especially in case of wireless communication between the central module 200 and the peripheral module 100, a feedback on the successful interpretation of the barcode 400 at the central module 200 is also output at the peripheral module 100. The respective information data 320 preferably are transmitted in XML or HTML format so that the display 140 of the peripheral module 100 can output the messages in a formatted manner.

To achieve this, a first (software) application at the peripheral module 100 and a second (software) application at the central module 200 are required. The processor 120 of the peripheral module 100 is equipped with the first application, and the processor 210 of the central module 200 is equipped with the second application.

The first application supervises the code reader 110 of the peripheral module 100. When the code reader 110 has scanned a barcode 400, the corresponding code data 310 are transmitted from the transmitter 130 via a wireless connection (network address and port) determined in advance, to the central module 200. Then, a response is expected from the central module 200, confirming the successful scanning and processing of the barcode 400 and indicating further scanning processes and/or actions to be carried out, if needed. The response is displayed on the display 140 of the peripheral module 100. This first application preferably is kept as simple as possible to be able to be quickly transferred to different operating systems of the peripheral modules 100.

For the second application, there is a difference between the administration and/or documentation software (main task) and the code interpreter (secondary task). The main software can cover different functions and can be used for different main purposes such as for example the documentation of a surgical operation and/or different secondary purposes such as for example the detection of surgical materials via their barcodes. The code interpreter is a sub-application, which communicates with the peripheral module 100 on the basis of standards and free configuration, interprets the barcode detected by the code reader 110, asks for additional scanning processes if needed, and passes the results on to the main software in a standardized format (e.g. XML).

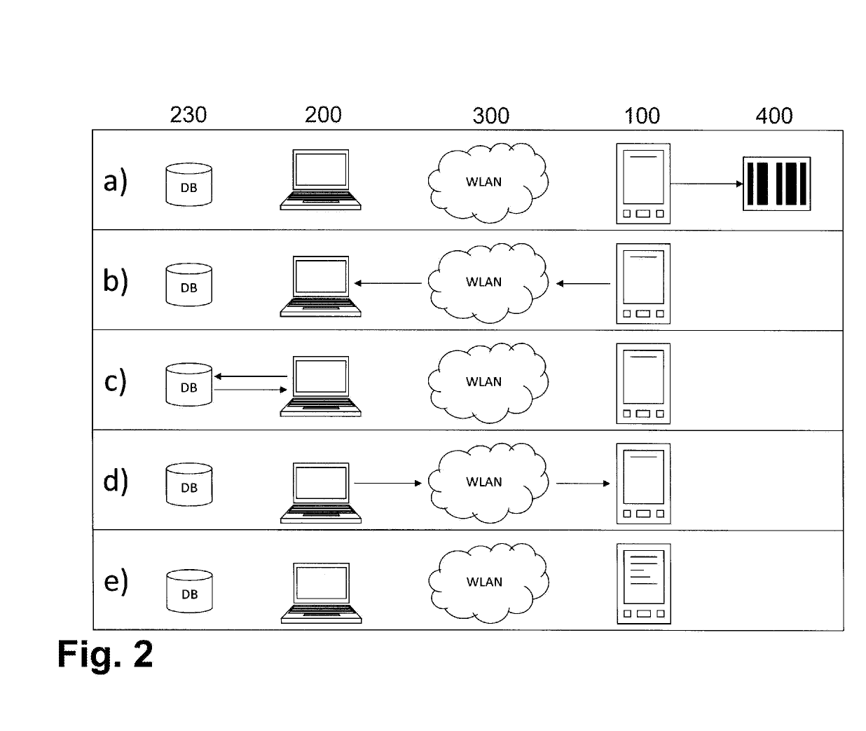

FIG. 2 illustrates the communication between the first application running on the processor 120 of the peripheral module 100 and the code interpreter running on the processor 210 of the central module 200.

In step a), the barcode 400 is scanned by the code reader 110 of the peripheral module 100. The processor 120 of the peripheral module 100 carries out a pre-processing of the barcode to distinguish general barcodes from barcodes for device control. The next steps explained all refer to the detection of general barcodes.

In step b), the peripheral module 100 transmits the code data 310 corresponding to the barcode 400 to the central module 200. The processor 120 and/or the transmitter 130 of the peripheral module 100 have stored the target IP address and port of the central module 200.

In step c), the processor 210 of the central module 200 uses the code interpreter and the database 230 to analyze and process the received code data 310, and to link them with further information stored in the database 230. In some cases, the process may be closed now.

In step d), the central module 200 transmits some information data 320 to the peripheral module 100 giving a feedback on the scan and communication process. The processor 210 of the central module 200 generates corresponding information data 320 in XML format, for example, and the transmitter 225 transmits them to the known IP address and port of the peripheral module 100.

In step e), the peripheral module 100 displays the formatted message on the display 140 to be read by the user of the peripheral module 100.

A concrete example of the procedure described above may be as follows.

a) The code reader 110 of the peripheral module 100 scans a barcode 400 of the type GS1-128 having the content “0108717648123634”.

b) The processor 120 of the peripheral module 100 generates code data 310 having the content “<scan>]C10108717648123634</scan>”. The transmitter 130 of the peripheral module 100 sends these code data to the port “49155” (receiver 220) of the central module 200 having the IP address “192.168.0.123” via WLAN 300.

c) The second application running on the processor 210 of the central module 200 receives those code data 310 and processes them with the code interpreter. The code interpreter determines that the code data 310 represent a barcode of type GS1-128 so that its content shall be analyzed according to the GS1 specifications. In the present case, the code interpreter will recognize that the code data represent an item number (GTIN 08717648123634) being assigned to a specific coronary stent system, on the basis of the information contained in the database 230. Furthermore, the code interpreter recognizes that this stent system requires a lot number which is not included in the barcode 400 scanned by the code reader 110, referring to the database 230.

d) The second application at the processor 210 of the central module 200 then generates the following text:

<reply>

<type>article </type>
<name>coronary stent system ABC</name>
<proceed>This item is subject to lot number. Please also scan

the

lot number. Note: it is at ..(10).. in the column of figures

below the

barcode.</proceed>

</reply>

This text is sent to the IP address of the peripheral module 100 (e.g. “192.168.0.201:49501”).

e) The processor 120 of the peripheral module 100 recognizes the XML information data 320 received at the receiver 135. The processor 120 controls the display 140 to display the name of the scanned item and the message that further scans are required.

f) The procedure starts again. The code reader 110 of the peripheral module 100 scans a barcode 400 of type GS1-128 having the content “17110308100022541”.

g) The processor 120 of the peripheral module 100 generates code data 310 having the content “<scan>] C117110308100022541</scan>”. The transmitter 130 of the peripheral module 100 sends these code data to the central module 200 via WLAN 300.

h) The second application running on the processor 210 of the central module 200 receives those code data 310. The code interpreter determines that the code data 310 represent a barcode of type GS1-128 so that its content shall be analyzed according to the GS1 specifications. In the present case, the code interpreter will recognize that the code data represent an expiry date (“08.03.2011”) and a lot number (“0022541”). The processor 210 of the central module 200 now can mark the corresponding item (coronary stent system in this example) as being consumed. Further, the code interpreter determines that the data are complete now and no further scans are required, referring to the database 230. Optionally, this information can be also displayed on the display 240 of the central module 200.

i) The second application at the processor 210 of the central module 200 then generates the following text:

<reply>

<type>article</type>
<name>coronary stent system ABC</name>
<lot>0022541</lot>
<expdate>08/03/2011</expdate>
<complete/>

</reply>

This text is sent to the IP address of the peripheral module 100 (e.g. “192.168.0.201:49501”).

k) The processor 120 of the peripheral module 100 recognizes the XML information data 320 received at the receiver 135. The processor 120 controls the display 140 to display the name of the scanned item as well as its lot number and its expiration date. The user will recognize that no further actions are required at the moment.

1-10. (canceled)

11: A system for detecting and processing codes, the system comprising:
at least one peripheral module including:
a code reader that reads codes;
a transmitter that transmits code data corresponding to the codes read by the code reader;
a receiver that receives information data; and
an output device that outputs messages corresponding to the information data received by the receiver; and
a central module including:
a receiver that receives the code data transmitted from the transmitter of the at least one peripheral module;
a processor that processes the code data received by the receiver of the central module and generates the information data to be received by the receiver of the at least one peripheral module, depending on the processed code data; and
a transmitter that transmits the information data generated by the processor.

12: The system according to claim 11, wherein the transmitter and/or the receiver of the at least one peripheral module transmits the code data or receives the information data, respectively, wirelessly; and the receiver and/or the transmitter of the central module receives the code data or transmits the information data, respectively, wirelessly.

13: The system according to claim 11, wherein the information data include confirmation data as to whether the code data have been received by the receiver of the central module and processed by the processor of the central module successfully or not.

14: The system according to claim 11, wherein the processor of the central module is connected to a database including data referring to the codes.

15: The system according to claim 14, wherein the information data include instruction data as to which further codes have to be detected and/or which further actions have to be carried out, the instruction data being generated by the processor of the central module depending on the data of the database referring to the code data received by the receiver of the central module.

16: The system according to claim 11, wherein the at least one peripheral module includes a processor that processes the codes read by the code reader and generates the code data to be transmitted to the central module.

17: The system according to claim 11, wherein the code reader is provided in a peripheral module that is capable of being used in the system.

18: The system according to claim 11, wherein the processor is provided in a central module that is capable of being used in the system.

19: A method for detecting and processing codes comprising the steps of:
detecting a code by a peripheral module;
transmitting code data corresponding to the code detected by the peripheral module to a central module;
processing the code data by the central module;
generating information data by the central module depending on the processed code data;
transmitting the information data from the central module to the peripheral module; and
outputting a message corresponding to the information data by the peripheral module.

20: The method according to claim 19, wherein the code data and/or the information data are transmitted wirelessly.
